(19) United States
(12) Patent Application Publication
(10) Pub. No.: US 2013/0091138 A1
(43) Pub. Date: Apr. 11, 2013

(54) Contextualization, mapping, and other categorization for data semantics

(71) Applicants: Christian Liensberger, Bellevue, WA (US); Rene Bouw, Kirkland, WA (US); Roger Soulen Mall, Sammamish, WA (US); Vineela Muppavarapu, Redmond, WA (US)

(72) Inventors: Christian Liensberger, Bellevue, WA (US); Rene Bouw, Kirkland, WA (US); Roger Soulen Mall, Sammamish, WA (US); Vineela Muppavarapu, Redmond, WA (US)

(73) Assignee: Microsoft Corporation, Redmond, WA (US)

(21) Appl. No.: 13/253,576

(22) Filed: Oct. 5, 2011

(51) Int. Cl. G06F 17/30

(52) U.S. Cl. 707/740; 707/E17.127; 707/E17.089

(57) ABSTRACT

Semantic categorization of data includes submitting obtained data values to a data enhancement service which has a semantic criterion for incoming data. A response from the service indicates whether the submitted data values meet the criterion, and is used to assign a likelihood that the values belong to a semantic category matching the criterion. Other semantic categorization operations do not necessarily use a data enhancement service. Some are based on which device was used to collect the data values, on a subject heading in which data was published, and/or on syntactic patterns. A semantic taxonomy shows semantic categorizations for one or more datasets and connections between datasets, possibly filtered per user request. Different versions of the taxonomy are stored for respective different users. Similarity between the data values can be assessed using semantic categorization. Taxonomies can be federated to allow exploration and understanding across multiple repositories.

### BACKGROUND

An ever-increasing amount and variety of digital data is available online, in local networks, on mobile devices, and through other channels. Digital data is organized in various ways, and to various extents. Some data values are solitary, in the sense that they do not belong (or at least are not treated as belonging) to a set of related data values. But many data values are part of a larger data set (a.k.a. “dataset”) which is often organized to facilitate operations such as retrieval of particular values, comparison of values, and computational summaries based on multiple values of the dataset.

A set of data values may be a simple collection with little or no internal structure, for which the main operations available are adding a value to the collection, checking to see whether a value is in the collection, and removing a value from the collection. But in many cases data in a set is structured, so that one can say more about it than a mere recital of its value and its membership in the dataset. In a spreadsheet dataset, for example, a given piece of data not only has a value and membership in the set of spreadsheet values, it also has an associated row and column, which may in turn have characteristics such as names and data types. Some familiar examples of structured data include relational database records, spreadsheets, tables, and arrays.

### SUMMARY

Despite data schemas and other structuring mechanisms, data values which appear to be different from each other may actually be closely related in meaning, and data values which appear similar may instead have very different meanings. In either case, integrating data and finding relationships among data values is hindered by a lack of semantic information about the data. However, some embodiments described herein provide or facilitate semantic categorization of data, which can in turn assist the productive use of datasets.

For instance, some embodiments perform semantic categorization by submitting obtained data values to a third party or other data enhancement service which has a semantic criterion for incoming data. For example, a service may be designed to convert street addresses to latitude-longitude coordinates, and so have semantic criteria suitable for recognizing street addresses. These embodiments receive a response from the data enhancement service that indicates whether the submitted data values actually meet the service's semantic criterion. If the criterion is met, there is an increased likelihood that the values belong to a semantic category (e.g., address-data) matching the service's criterion; if not, a decreased likelihood is assigned. An assigned “likelihood” may be absolute, or it may be a probability. Dataset semantic categorizations are a generalization of the dataset's schema.

Other semantic categorization operations do not necessarily use a data enhancement service. For example, some embodiments perform semantic categorization based on which device was used to collect the data values, e.g., some assign a semantic categorization of location-data to data collected from a mobile device. Some embodiments select a semantic categorization of data values based at least in part on a subject heading in which data was published, e.g., a subject heading applied by an educational institution or a governmental agency to a publication of the data values. Some embodiments include predefined syntactic patterns for semantically identifying data values, e.g., as street addresses, postal addresses, latitude-longitude coordinates, and so on. Some embodiments combine one or more of the operations described herein.

Some embodiments visualize a semantic taxonomy which shows semantic categorizations for one or more datasets. Shared semantic categorizations, shared owners, and other connections between datasets may also be shown. A filtering request may be used to show only a desired part of the taxonomy. Some embodiments store and retrieve different versions of the taxonomy, e.g., for respective different users. Some track taxonomy version usage. Some embodiments subject a version of the taxonomy to crowdsourcing to generate feedback on semantic categorizations of the taxonomy.

In addition to, or in lieu of, the foregoing, some embodiments perform other actions. Some proactively map a data record schema name to a semantic category in a hierarchy or mesh of semantic categories. Some assess similarity between the (uncategorized/tentatively categorized) data values obtained and other data values which have previously been semantically categorized, and (re)categorize accordingly. Some identify a semantic categorization of data values based on a syntactic pattern exhibited in the data values.

From an architectural perspective, some embodiments include at least one logical processor, and a memory in operable communication with the logical processor. In some, at least one data enhancement service interface also resides in the memory. A semantic categorization module contains semantic categorization code. Upon execution by the logical processor(s), that code will proactively submit data values to the data enhancement service interface, receive a response from the data enhancement service interface, and then assign a semantic categorization to the submitted data values based on the response.

Taxonomy federation is supported in some cases. Upon execution, taxonomy federation code will perform operations such as reporting that the same semantic categorization appears in different taxonomies or in different datasets.

Some embodiments include additional code, including for instance code which upon execution by the processor(s) will perform any or all of the actions, operations, or steps discussed herein. As a few examples, some embodiments include code to cleanse a dataset schema name; to assess similarity between a first dataset and a second dataset when at least one of the datasets has semantic categorizations; to get a request for a manual change or addition in a semantic categorization; and/or to suggest a relationship between datasets, based at least in part on semantic categorizations of the datasets.

Although automatic semantic categorization is provided in many embodiments, and is the only kind of semantic categorization provided in some embodiments, manual edits may also be performed on semantic categorization in some embodiments. Manual editing requests may come from users and/or from dataset publishers.

The examples given are merely illustrative. This Summary is not intended to identify key features or essential features of the claimed subject matter, nor is it intended to be used to limit the scope of the claimed subject matter. Rather, this Summary is provided to introduce—in a simplified form—some concepts that are further described below in the Detailed Description. The innovation is defined with claims, and to the extent this Summary conflicts with the claims, the claims should prevail.

### DESCRIPTION OF THE DRAWINGS

A more particular description will be given with reference to the attached drawings. These drawings only illustrate selected aspects and thus do not fully determine coverage or scope.

FIG. 1 is a block diagram illustrating a computer system having at least one processor, at least one memory, at least one dataset, a browser and/or other software (kernel and application software), and other items in an operating environment which may be present on multiple network nodes, and also illustrating configured storage medium embodiments;

FIG. 2 is a block diagram illustrating aspects of data semantic categorization in an example architecture;

FIG. 3 is a flow chart illustrating steps of some process and configured storage medium embodiments; and

FIG. 4 is a data flow diagram illustrating data semantic categorization and taxonomy federation in another example architecture.

### DETAILED DESCRIPTION

Overview

The amount of data being published has increased dramatically, and is likely to continue increasing in the future. However, much data contains noise in form of poor descriptions, ad hoc schema definitions, inconsistent naming, and so on, which makes it difficult to work with the data and harder to gain insights from the data. Additionally, variations of the same data sometimes exist in multiple formats, making it harder to integrate data and to establish relationships between data.

Some embodiments described herein facilitate automatic and manual annotation of data and applications that deal with data, in the form of semantic categorizations. Such annotations can help developers, data publishers, and users build smarter experiences on top of the data and applications. Semantic annotations can also help categorize data values, connect datasets, and derive new data from original data. The semantic annotations and other metadata can be built up into another dataset, which can be mined and used to gain further insights on how data relates, how it can be composed, and how it might be enhanced.

Some embodiments described herein may be viewed in a broader context. For instance, concepts such as categories, criteria, data, enhancement, services, sources, and visualization may be relevant to a particular embodiment. However, it does not follow from the availability of a broad context that exclusive rights are being sought herein for abstract ideas; they are not. Rather, the present disclosure is focused on providing appropriately specific embodiments.

Other media, systems, and methods involving categories, criteria, data, enhancement, services, sources, and/or visualization are outside the present scope. Accordingly, vagueness and accompanying proof problems are also avoided under a proper understanding of the present disclosure.

Reference will now be made to exemplary embodiments such as those illustrated in the drawings, and specific language will be used herein to describe the same. But alterations and further modifications of the features illustrated herein, and additional applications of the principles illustrated herein, which would occur to one skilled in the relevant art(s) and having possession of this disclosure, should be considered within the scope of the claims.

The meaning of terms is clarified in this disclosure, so the claims should be read with careful attention to these clarifications. Specific examples are given, but those of skill in the relevant art(s) will understand that other examples may also fall within the meaning of the terms used, and within the scope of one or more claims. Terms do not necessarily have the same meaning here that they have in general usage, in the usage of a particular industry, or in a particular dictionary or set of dictionaries. Reference numerals may be used with various phrasings, to help show the breadth of a term. Omission of a reference numeral from a given piece of text does not necessarily mean that the content of a Figure is not being discussed by the text. The inventors assert and exercise their right to their own lexicography. Terms may be defined, either explicitly or implicitly, here in the Detailed Description and/or elsewhere in the application file.

As used herein, a “computer system” may include, for example, one or more servers, motherboards, processing nodes, personal computers (portable or not), personal digital assistants, cell or mobile phones, other mobile devices having at least a processor and a memory, and/or other device(s) providing one or more processors controlled at least in part by instructions. The instructions may be in the form of firmware or other software in memory and/or specialized circuitry. In particular, although it may occur that many embodiments run on workstation or laptop computers, other embodiments may run on other computing devices, and any one or more such devices may be part of a given embodiment.

A “multithreaded” computer system is a computer system which supports multiple execution threads. The term “thread” should be understood to include any code capable of or subject to scheduling (and possibly to synchronization), and may also be known by another name, such as “task,” “process,” or “coroutine,” for example. The threads may run in parallel, in sequence, or in a combination of parallel execution (e.g., multiprocessing) and sequential execution (e.g., time-sliced). Multithreaded environments have been designed in various configurations. Execution threads may run in parallel, or threads may be organized for parallel execution but actually take turns executing in sequence. Multithreading may be implemented, for example, by running different threads on different cores in a multiprocessing environment, by time-slicing different threads on a single processor core, or by some combination of time-sliced and multi-processor threading. Thread context switches may be initiated, for example, by a kernel's thread scheduler, by user-space signals, or by a combination of user-space and kernel operations. Threads may take turns operating on shared data, or each thread may operate on its own data, for example.

A “logical processor” or “processor” is a single independent hardware thread-processing unit, such as a core in a simultaneous multithreading implementation. As another example, a hyperthreaded quad core chip running two threads per core has eight logical processors. Processors may be general purpose, or they may be tailored for specific uses such as graphics processing, signal processing, floating-point arithmetic processing, encryption, I/O processing, and so on.

A “multiprocessor” computer system is a computer system which has multiple logical processors. Multiprocessor environments occur in various configurations. In a given configuration, all of the processors may be functionally equal, whereas in another configuration some processors may differ from other processors by virtue of having different hardware capabilities, different software assignments, or both. Depending on the configuration, processors may be tightly coupled to each other on a single bus, or they may be loosely coupled. In some configurations the processors share a central memory, in some they each have their own local memory, and in some configurations both shared and local memories are present.

“Kernels” include operating systems, hypervisors, virtual machines, BIOS code, and similar hardware interface software.

“Code” means processor instructions, data (which includes constants, variables, and data structures), or both instructions and data.

“Program” is used broadly herein, to include applications, kernels, drivers, interrupt handlers, libraries, and other code written by programmers (who are also referred to as developers).

“Automatically” means by use of automation (e.g., general purpose computing hardware configured by software for specific operations discussed herein), as opposed to without automation. In particular, steps performed “automatically” are not performed by hand on paper or in a person's mind; they are performed with a machine.

“Computationally” likewise means a computing device (processor plus memory, at least) is being used, and excludes obtaining a result by mere human thought or mere human action alone. For example, doing arithmetic with a paper and pencil is not doing arithmetic computationally as understood herein. Computational results are faster, broader, deeper, more accurate, more consistent, more comprehensive, and/or otherwise beyond the scope of human performance alone. “Computational steps” are steps performed computationally. Neither “automatically” nor “computationally” necessarily means “immediately”.

“Proactively” means without a direct request from a user. Indeed, a user may not even realize that a proactive step by an embodiment was possible until a result of the step has been presented to the user. Except as otherwise stated, any computational and/or automatic step described herein may also be done proactively.

Throughout this document, use of the optional plural “(5)”, “(es)”, or “(ies)”, and so on, means that one or more of the indicated feature is present. For example, “dataset(s)” means “one or more datasets” or equivalently “at least one dataset”.

It is understood that “based on” means “based at least in part on” regardless of whether “at least in part” is recited, unless expressly stated otherwise.

Throughout this document, unless expressly stated otherwise any reference to a step in a process presumes that the step may be performed directly by a party of interest and/or performed indirectly by the party through intervening mechanisms and/or intervening entities, and still lie within the scope of the step. That is, direct performance of the step by the party of interest is not required unless direct performance is an expressly stated requirement. For example, a step involving action by a party of interest such as assessing, assigning, choosing, cleansing, connecting, displaying, filtering, getting, identifying, implementing, indicating, mapping, obtaining, performing, receiving, reporting, selecting, storing, subjecting, submitting, suggesting, tracking, visualizing (or assesses, assessed, assigns, assigned, and so on) with regard to a destination or other subject may involve intervening action such as forwarding, copying, uploading, downloading, encoding, decoding, compressing, decompressing, encrypting, decrypting, authenticating, invoking, and so on by some other party, yet still be understood as being performed directly by the party of interest.

Whenever reference is made to data or instructions, it is understood that these items configure a computer-readable memory and/or computer-readable storage medium, thereby transforming it to a particular article, as opposed to simply existing on paper, in a person's mind, or as a transitory signal on a wire, for example. Unless expressly stated otherwise in a claim, a claim does not cover a signal per se. A memory or other computer-readable medium is presumed to be non-transitory unless expressly stated otherwise.

Operating Environments

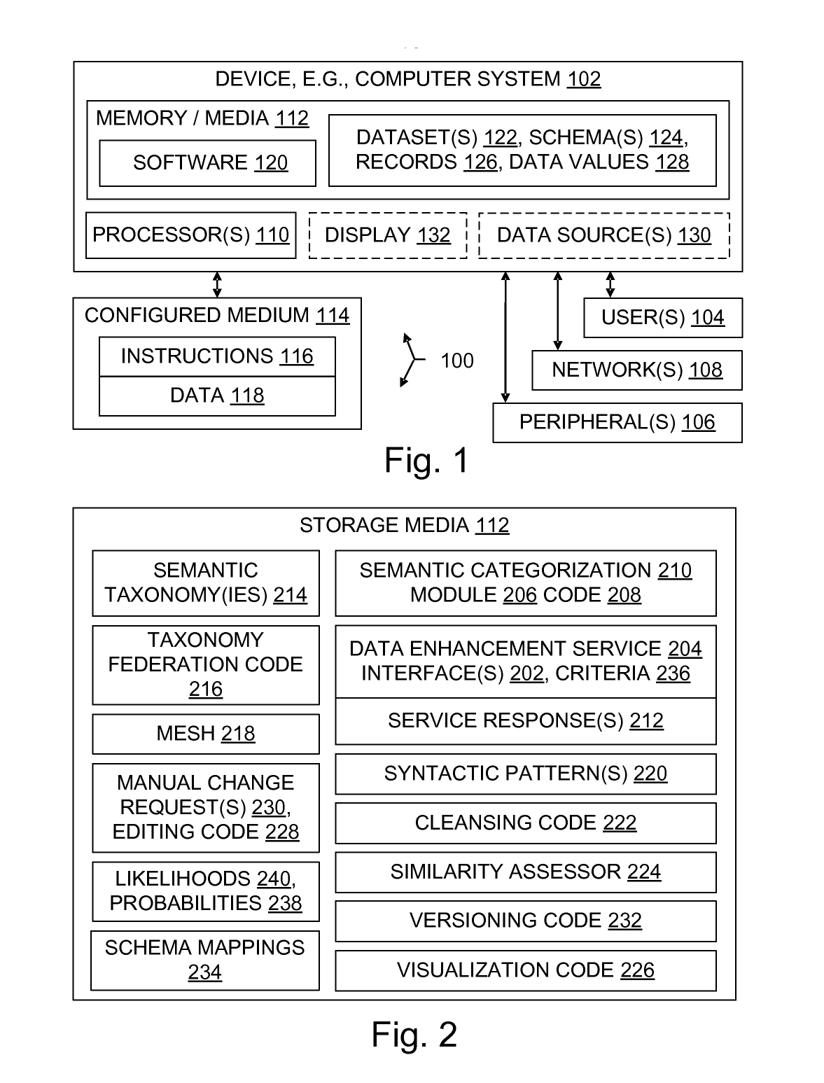

With reference to FIG. 1, an operating environment 100 for an embodiment may include a computer system 102. The computer system 102 may be a multiprocessor computer system, or not. An operating environment may include one or more machines in a given computer system, which may be clustered, client-server networked, and/or peer-to-peer networked. An individual machine is a computer system, and a group of cooperating machines is also a computer system. A given computer system 102 may be configured for end-users, e.g., with applications, for administrators, as a server, as a distributed processing node, and/or in other ways.

Human users 104 may interact with the computer system 102 by using displays, keyboards, and other peripherals 106. System administrators, data publishers, developers, engineers, and end-users are each a particular type of user 104. Automated agents acting on behalf of one or more people may also be users 104. Storage devices and/or networking devices may be considered peripheral equipment in some embodiments. Other computer systems not shown in FIG. 1 may interact with the computer system 102 or with another system embodiment using one or more connections to a network 108 via network interface equipment, for example.

The computer system 102 includes at least one logical processor 110. The computer system 102, like other suitable systems, also includes one or more computer-readable non-transitory storage media 112. Media 112 may be of different physical types. The media 112 may be volatile memory, non-volatile memory, fixed in place media, removable media, magnetic media, optical media, and/or of other types of non-transitory media (as opposed to transitory media such as a wire that merely propagates a signal). In particular, a configured medium 114 such as a CD, DVD, memory stick, or other removable non-volatile memory medium may become functionally part of the computer system when inserted or otherwise installed, making its content accessible for use by processor 110. The removable configured medium 114 is an example of a computer-readable storage medium 112. Some other examples of computer-readable storage media 112 include built-in RAM, ROM, hard disks, and other storage devices which are not readily removable by users 104. Unless expressly stated otherwise, neither a computer-readable medium nor a computer-readable memory includes a signal per se.

The medium 114 is configured with instructions 116 that are executable by a processor 110; “executable” is used in a broad sense herein to include machine code, interpretable code, and code that runs on a virtual machine, for example. The medium 114 is also configured with data 118 which is created, modified, referenced, and/or otherwise used by execution of the instructions 116. The instructions 116 and the data 118 configure the medium 114 in which they reside; when that memory is a functional part of a given computer system, the instructions 116 and data 118 also configure that computer system. In some embodiments, a portion of the data 118 is representative of real-world items such as product characteristics, inventories, physical measurements, settings, images, readings, targets, volumes, and so forth. Such data is also transformed by semantic categorization and otherwise as discussed herein.

A kernel, a web browser, other applications, and other software 120, as well as other items shown in the Figures and/or discussed in the text, may reside partially or entirely within one or more media 112, thereby configuring those media. A dataset 122 may have a schema 124 such as column names or an XML schema or a database schema, may have records 126 such as database records or spreadsheet rows, and does have data values 128. Datasets 122 are provided by data sources 130, e.g., web services, file systems, applications, network connections, marketplaces, and so on. “Marketplace” includes, for example, an online marketplace, such as a data and/or data enhancement services marketplace, as well as white-label or other marketplace versions that distribute to a closed group rather than the general public. In addition to the processor(s) 110, memory 112, and a display 132, an operating environment may also include other hardware such as buses, power supplies, and accelerators, for instance.

One or more items are shown in outline form in FIG. 1 to emphasize that they are not necessarily part of the illustrated operating environment, but may interoperate with items in the operating environment as discussed herein. It does not follow that items not in outline form are necessarily required, in any Figure or any embodiment.

Systems

FIG. 2 illustrates an architecture which is suitable for use with some embodiments. With reference to FIGS. 1 and 2, some embodiments include at least one logical processor 110, and a memory 112 in operable communication with the logical processor. In some, at least one data enhancement service interface 202 to a data enhancement service 204 also resides in the memory 112. Although service 204 is shown in FIG. 2 for convenience, the data enhancement service 204 itself (as opposed to the interface 202) may reside in the same memory as the interface 202 as shown, or it may instead be located elsewhere, e.g., in another computing cluster or on another network 108 node.

In some embodiments, a semantic categorization module 206 resides in the memory 112. The module 206 is in operable communication with the data enhancement service interface(s) 202. The module 206 contains semantic categorization code 208, namely, code that performs some aspect of semantic categorization 210. Upon execution by the logical processor(s) 110, that code 208 may proactively submit data values 128 to the data enhancement service interface 202, receive a response 212 from the data enhancement service 204 via the interface 202 reflecting the service's semantic criteria 236, and then assign a semantic categorization 210 (probability 238 or other likelihood 240) to the submitted data values 128 based on the service's response 212. In some embodiments, the semantic categorization module 206 is owned by an entity X, and the data enhancement service interface(s) 202 connect the semantic categorization module with at least one “third party” data enhancement service 204, namely, a service which is owned by another entity Y. In particular, the data enhancement service 204 may be offered in some environments through a marketplace, such as the Microsoft® Windows Azure™ Marketplace (marks of Microsoft Corporation).

Taxonomy federation is supported in some cases. For example, some embodiments contain a first semantic taxonomy 214, which includes a first plurality of semantic categorizations 210 of data values of a first dataset, and some of these embodiments also contain taxonomy federation code 216. Upon execution by the logical processor(s) 110, the taxonomy federation code 216 will access a second semantic taxonomy 214, which includes a second plurality of semantic categorizations 210 of data values of a second dataset. Then the taxonomy federation code 216 will perform one or more taxonomy federation operations. For instance, the taxonomy federation code 216 may report that a semantic categorization 210 appears in both the first taxonomy and the second taxonomy, and/or report that multiple semantic categorizations 210 appear in both the first taxonomy and the second taxonomy. The taxonomy federation code 216 may report that the second dataset 122 has at least one semantic categorization in common with the first dataset, and/or report that the second dataset has multiple semantic categorizations in common with the first dataset.

Some embodiments include a dataset 122 which has a schema 124. In some, the dataset 122 also has associated semantic categorizations 210, which are semantically a generalization of the schema 124, individually and/or collectively. In some embodiments, the semantic categorizations are connected within a hierarchy or other mesh 218 of semantic categorizations. For example, a schema name might be “addr”, which is generalized to a semantic categorization street-address, which is turn is linked in the mesh 218 to the broader semantic categorization contact-information and to sibling semantic categorizations email-address and telephone-number.

Some embodiments include one or more predefined syntactic patterns 220 for semantically identifying data values. For example, such patterns 220 may identify data values as street addresses, postal addresses, latitude-longitude coordinates, email addresses, website addresses, telephone numbers, calendar dates, gender information, city and state/province/country information, or postal codes. Familiar lexical analysis and parsing mechanisms may be used by the patterns 220.

Some embodiments include other code, including for instance code which upon execution by the processor(s) will computationally perform any or all of the actions, operations, or steps discussed herein. As a few examples, some embodiments include code 222 to cleanse a dataset schema name, and some include code in an assessor 224 to assess similarity between a first dataset and a second dataset when at least one of the datasets has semantic categorizations.

In some embodiments code 208 will choose a semantic categorization of a data value based at least in part on which device was used to collect the data value. In some, code 208 will select a semantic categorization of a data value based at least in part on a subject heading applied in a publication of the data value.

Some embodiments include code 226 to visualize for a user 104 a taxonomy 214 which shows a plurality of semantic categorizations 210. Some include code 228 to get a request 230 for a manual change or addition in a semantic categorization. Some include versioning code 232 to store/retrieve different versions of a semantic taxonomy, and/or to track respective usage of different versions of a semantic taxonomy. In some, code 208 will suggest a relationship between datasets, based at least in part on semantic categorizations of the datasets.

These and other aspects may be combined in various ways in different embodiments. For example, some embodiments provide a computer system 102 with at least one logical processor 110, a memory 112 in operable communication with the logical processor, at least one data enhancement service interface 202 residing in the memory, and a semantic categorization module 206 residing in the memory in operable communication with the data enhancement service interface(s). The semantic categorization module 206 contains code 208 which upon execution by the logical processor(s) will proactively submit data values 128 to the data enhancement service interface 202, receive a response 212 from the data enhancement service interface, and then assign a semantic categorization 210 to the submitted data values based on the response.

In some embodiments, the system 102 further includes a first semantic taxonomy 214 which includes a first plurality of semantic categorizations 210 of data values of a first dataset 122, and taxonomy federation code 216. Upon execution by the logical processor(s), code 216 will access a second semantic taxonomy 214 which includes a second plurality of semantic categorizations 210 of data values of a second dataset 122, and then perform at least one of the following taxonomy federation operations: report that a semantic categorization appears in both the first taxonomy and the second taxonomy; report that multiple semantic categorizations 210 appear in both the first taxonomy and the second taxonomy; report that the second dataset 122 has at least one semantic categorization in common with the first dataset; report that the second dataset has multiple semantic categorizations in common with the first dataset.

In some embodiments, the semantic categorization module 206 is owned by an entity, e.g., a corporation, other business entity, educational institution, or governmental agency. The data enhancement service interface(s) 212 connect the semantic categorization module 206 with at least one third party data enhancement service 204 that is not necessarily local, and is owned by another entity. This would occur frequently in using services 204 accessed through a marketplace, for example.

In some embodiments, the system 102 further includes a dataset 122 having a schema 124 and having semantic categorizations 210 which are a generalization of the schema. In some, the semantic categorizations 210 are connected within a mesh 218 of semantic categorizations.

In some embodiments, the system 102 further includes one, two, three, or another specified number, or at least a specified number, of the following predefined syntactic patterns 220: a pattern for identifying data values as street addresses; a pattern for identifying data values as postal addresses; a pattern for identifying data values as latitude-longitude coordinates; a pattern for identifying data values as email addresses; a pattern for identifying data values as website addresses; a pattern for identifying data values as telephone numbers; a pattern for identifying data values as calendar dates; a pattern for identifying data values as gender information; a pattern for identifying data values as city and state information; a pattern for identifying data values as postal codes.

In some embodiments, the system 102 further includes code 222 which upon execution by the processor(s) will cleanse a dataset schema name, e.g., by removing non-alphabetic characters or removing non-alphanumeric characters.

Some systems 102 include code 224 which upon execution by the processor(s) will assess similarity between a first dataset and a second dataset, at least one of the datasets having semantic categorizations, e.g., by comparing data types, syntactic pattern matches, shared semantic categorizations 210, and/or shared schema components. Some systems 102 include code 224 which upon execution by the processor(s) will suggest a relationship between datasets, based at least in part on semantic categorizations of the datasets, such as a set relationship, e.g., non-empty intersection, empty intersection, or set containment of one dataset's categorizations in the other dataset's categorizations.

Some systems 102 include code 208 which upon execution by the processor(s) will choose a semantic categorization of a data value based at least in part on which device was used to collect the data value. This may be done, e.g., by assigning “location” as the categorization 210 for data collected from a global positioning system device.

Some systems 102 include code 208 which upon execution by the processor(s) will select a semantic categorization of a data value based at least in part on a subject heading applied in a publication of the data value. This may be done, e.g., by mapping 234 from the subject heading text to a list of keywords associated with a semantic categorization 210.

Some systems 102 include code 226 which upon execution by the processor(s) will visualize for a user a taxonomy 214 which shows a plurality of semantic categorizations 210. For example, familiar graph building and displaying mechanisms may be adapted to visualize graphs whose nodes are datasets and whose links are shared categorization(s) 210.

Some systems 102 include semantic categorization editing code 228 which upon execution by the processor(s) will get a request 230 for a manual change in and/or a manual addition of a semantic categorization. Requests 230 may be gotten by code 228, e.g., through a command line interface, a graphical user interface, or a web service interface.

Some systems 102 include versioning code 226 which upon execution by the processor(s) will store and/or retrieve different versions of a semantic taxonomy in/from non-volatile storage. Some code 226 will track respective usage of different versions of a semantic taxonomy.

In some embodiments peripherals 106 such as human user I/O devices (screen, keyboard, mouse, tablet, microphone, speaker, motion sensor, etc.) will be present in operable communication with one or more processors 110 and memory. However, an embodiment may also be deeply embedded in a system, such that no human user 104 interacts directly with the embodiment. Software processes may be users 104.

In some embodiments, the system includes multiple computers connected by a network. Networking interface equipment can provide access to networks 108, using components such as a packet-switched network interface card, a wireless transceiver, or a telephone network interface, for example, will be present in a computer system. However, an embodiment may also communicate through direct memory access, removable nonvolatile media, or other information storage-retrieval and/or transmission approaches, or an embodiment in a computer system may operate without communicating with other computer systems.

Some embodiments operate in a “cloud” computing environment and/or a “cloud” storage environment in which computing services are not owned but are provided on demand. For example, datasets 122 may be stored on and obtained from multiple devices/systems 102 in a networked cloud, semantic categorization modules 206 and other code 204, 208, 220, 222, 224, 226, 232 may run on yet other devices within the cloud, and the taxonomy(ies) 214 may configure the display(s) 132 on yet other cloud device(s)/system(s) 102.

Processes

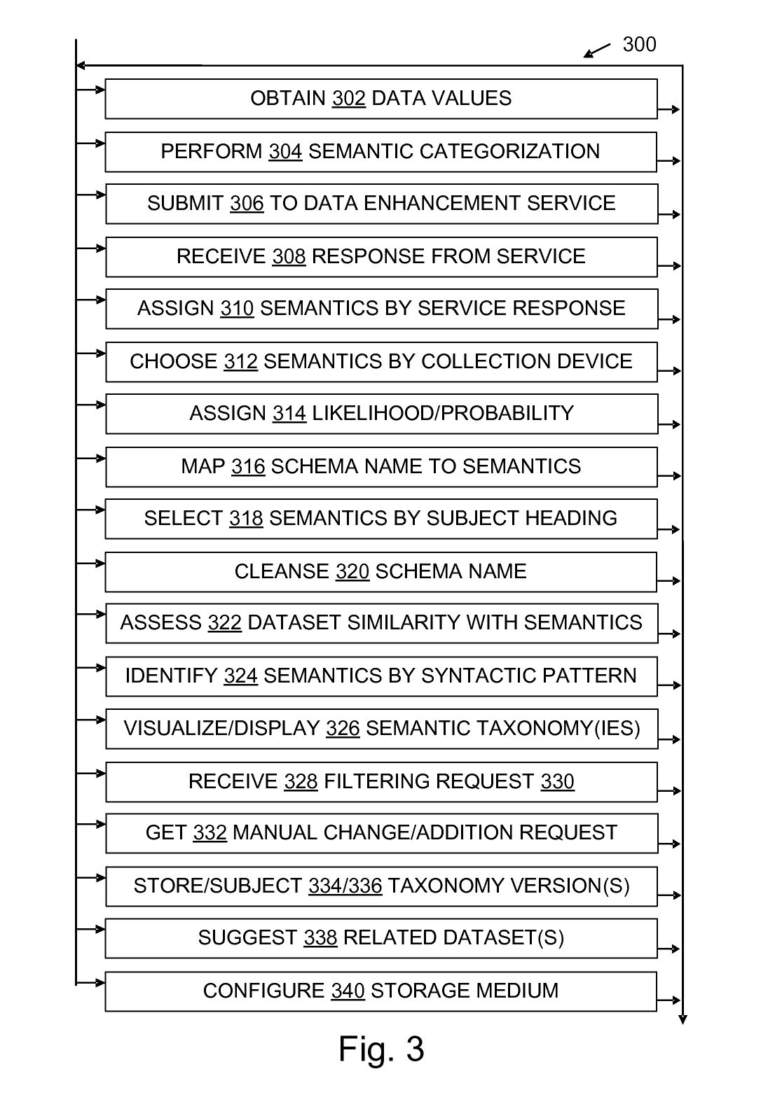

FIG. 3 illustrates some process embodiments in a flowchart 300. Processes shown in the Figures may be performed in some embodiments automatically, e.g., by a semantic categorization module 210 in a pipeline driven by search requests from a browser, or an application under control of a script or otherwise requiring little or no contemporaneous user input. Processes may also be performed in part automatically and in part manually unless otherwise indicated. In a given embodiment zero or more illustrated steps of a process may be repeated, perhaps with different parameters or data to operate on. Steps in an embodiment may also be done in a different order than the top-to-bottom order that is laid out in FIG. 3. Steps may be performed serially, in a partially overlapping manner, or fully in parallel. The order in which flowchart 300 is traversed to indicate the steps performed during a process may vary from one performance of the process to another performance of the process. The flowchart traversal order may also vary from one process embodiment to another process embodiment. Steps may also be omitted, combined, renamed, regrouped, or otherwise depart from the illustrated flow, provided that the process performed is operable and conforms to at least one claim.

Examples are provided herein to help illustrate aspects of the technology, but the examples given within this document do not describe all possible embodiments. Embodiments are not limited to the specific implementations, arrangements, displays, features, approaches, or scenarios provided herein. A given embodiment may include additional or different features, mechanisms, and/or data structures, for instance, and may otherwise depart from the examples provided herein.

During a data value obtaining step 302, an embodiment obtains data values 128. Step 302 may be accomplished using familiar data sources 130 and/or other mechanisms, for example.

During a semantic categorization performing step 304, an embodiment performs at least one operation that assigns 310, 314, chooses 312, maps 316, selects 318, identifies 324, gets 332, and/or otherwise associates a semantic categorization 210 with one or more data values.

During a data value submitting step 306, an embodiment submits data value(s) to a data enhancement service 204, via an interface 202 such as an API (application program interface), using files, by network connections, and/or by other familiar mechanisms.

During a service response receiving step 308, an embodiment receives a response 212 from a data enhancement service 204, via an interface 202, using files, network connections, and/or by other familiar mechanisms.

During a semantics-by-service-response assigning step 310, an embodiment assigns to a data value 128 a semantic categorization (in the form of a likelihood 240). Assignment is based on the response 212 received 308 after submitting 306 data values to a service 204.

During a semantics-by-collection-device choosing step 312, an embodiment assigns to a data value 128 a semantic categorization (in the form of a likelihood 240) based on the remote device 102 (e.g., user smartphone, user laptop, workstation, etc.) that was used to initially collect the data value 128. In general, this collection device may be a different device than the one running the semantic categorization module 206.

During a likelihood assigning step 314, an embodiment assigns at least one semantic categorization 210 in the form of a likelihood 240; “likelihood” and “semantic categorization” are sometime used herein as shorthand for each other. In some embodiments, a likelihood 240 is a set of one or more semantic categorizations 210 associated with a set of one or more data values, including both absolute categorizations and probability categorizations. For example, a column of data from a spreadsheet may be assigned 314 an 80% probability of being individual-name categorization data and 20% probability of being business-name categorization data, and a database record field may be assigned 314 an individual-name categorization and an offline-identity categorization 210. Zero probability may be assigned as a mechanism for ruling out a particular categorization 210, and “unknown” or “unassigned” may be used as a placeholder categorization 210.

During a schema name to semantics mapping step 316, a dataset schema name is mapped to at least one semantic categorization 210. Step 316 may be accomplished on the basis of the schema name itself, on the basis of the type of data named by the schema name, and/or on the basis of statistical information about the frequency with which particular schema names and/or data value types are associated with each other. As an example of the latter, if a numeric (or partially numeric and remainder alphabetic) field is present with a fully alphabetic field, then it may be assumed that the alphabetic field is likely an individual-name and the other field is likely an individual-identifier such as an employee number or badge number or social security number or member number, because those two field categorizations often occur together in datasets.

During a semantics-by-subject-heading selecting step 318, an embodiment assigns to a data value 128 a semantic categorization (in the form of a likelihood 240) based on a subject heading the data value was published under.

Publication may be local or global, in a shared file system, in a web page or otherwise online, for instance, in any computer-readable medium accessible to the system 102. Subject headings may be formal, e.g., US Library of Congress headings, US Patent and Trademark Office or other patent or trademark office classification descriptions, SIC (standard industrial code) code labels, etc. Subject headings may be informal, being promulgated only by a small group, a single business, or an individual, for instance. Subject headings may be found by natural language parsing and vision processing, because they often appear as their own paragraph and/or as sentence fragments, and are sometimes indicated by visual characteristics such as a larger font, bold face, and/or underlining, and may be followed immediately by a colon. In web pages, titles and other subject headings are locatable computationally using HTML Heading tags.

During a schema name cleansing step 320, an embodiment cleanses a schema name by placing it in a standard form, or at least closer to a standard form. Step 320 may include, e.g., correcting spelling errors, removing non-alphabetic or non-alphanumeric characters, expanding abbreviations, translating to a particular natural language, and so on.

During a dataset similarity assessing step 322, an embodiment computationally assesses aspects of semantic similarity (if any) between two or more datasets. Similarity assessment may include performing 304 semantic categorization as a preliminary action so that categorizations 210 are available to compare. Semantic similarity may be assessed by comparing the respective categorizations 210 to identify shared, non-shared, and mesh-related categorizations. As to “mesh-related”, categorizations 210 can be linked in a mesh 218 and thereby related. For example, in one mesh individual-name is related to contact-information as a detail; other categorizations 210 can be related in other ways, e.g., as alternatives to one another.

During a semantics-by-syntactic-pattern identifying step 324, an embodiment assigns a semantic categorization to data based on the result of applying a syntactic pattern 220 to the data.

During a taxonomy visualizing step 326, also referred to as a taxonomy displaying step 326, an embodiment displays at least a portion of at least one taxonomy 214 on a printout or a display 132 screen. Step 326 may use familiar computer graphics mechanisms to visualize a graph of categorizations 210, for example.

During a filtering request receiving step 328, an embodiment receives a filtering request 330 (and in some embodiments implements the request), as part of or in conjunction with taxonomy visualizing step 326, to filter in and/or filter out portion(s) of taxonomy(ies) to display 326. Any filter normally used on data values may be used, in some embodiments, as may filters that are specific to semantic categorization such as those that specify particular categorizations 210. For example, an embodiment might filter out personal-identifying-information data values but list the names of all detail categorizations of the personal-identifying-information categorization 210, and also filter out any categorization 210 that is not associated with data values of at least two datasets in a specified collection of datasets 122.

During a manual edit request getting step 332, an embodiment gets a request 230 for manual edits to one or more taxonomies 214 and/or to the collection of system-recognized semantic categorizations 210 (and in some embodiments implements the request). In contrast with filtering step 328, manual editing step 332 when implemented changes not only the displayed 326 information but also the underlying semantic categorization(s) 210.

During a taxonomy version storing step 334, an embodiment stores a particular version of a taxonomy 214, in the context of other stored versions of that taxonomy. For example, different users may assign different semantic categorizations 210 to the same data values in the different versions. Familiar version control software, such as that used with document version control or source code version control, may be adapted for use as versioning code 232 to perform step 334, and to perform related steps such as retrieval of a specified version of a taxonomy and determining the differences between two versions of a taxonomy 214.

During a taxonomy crowdsource subjecting step 336, an embodiment submits a particular version of a taxonomy 214 to crowdsourcing. Step 336 may be done to get feedback on assigned, chosen, selected, etc. categorizations, for example, and/or to seek categorizations 210 of data values whose categorization 210 is still unknown. Familiar crowdsourcing mechanisms may be adapted to present taxonomy(ies) and get feedback on them.

During a related dataset suggesting step 338, an embodiment suggests to a user 104 one or more other datasets that are related to a specified group of one or more datasets 122. Suggestions may be based on shared or mesh-related semantic categorizations 210 and/or based on a result of assessing step 322, for example.

During a memory configuring step 340, a memory medium 112 is configured by a semantic categorization module 206, a similarity assessor 224, taxonomy versioning code 232, and/or otherwise in connection with semantic categorization as discussed herein.

The foregoing steps and their interrelationships are discussed in greater detail below, in connection with various embodiments.

For instance, some embodiments obtain 302 data values 128, e.g., in data records, from an application program, website, web service, database management system, data store, XML document, or other data source 130. Some embodiments perform 304 semantic categorization by submitting the data values to a data enhancement service 204 which has at least one semantic criterion 236 for incoming data. For example, a first service 204 may be designed to convert street addresses to latitude-longitude coordinates, while a second service 204 will convert telephone numbers to city and state values. The first service 204 has semantic criteria 236 suitable for street addresses, and the second has semantic criteria 236 suitable for telephone numbers. As criteria 236 examples, a US address normally contains text which matches an entry in an established list of US states and possessions, and a US telephone number normally contains seven digits exclusive of the area code and any extension number.

After submitting data, these embodiments receive 308 a response 212 from the data enhancement service that indicates whether the submitted data values meet the service's semantic criterion/criteria for input data. If the response 212 indicates that the submitted data values do meet at least one service semantic criterion 236, these embodiment assign 314 an increased likelihood 240 that those values 128 belong to a semantic category 210 matching the service's semantic criterion/criteria. If the response 212 indicates the data service's criteria 236 are not met, a decreased likelihood 240 is assigned 314. Assignments 310 can use an internal mapping between data enhancement service identifiers and semantic categorizations, e.g., service ABC expects phone-data, or an embodiment may query suitably equipped service interfaces 202 on the fly to determine what semantic categories the service 204 expects.

If the data enhancement service's semantic criteria are met, the service will normally perform the service it was designed to perform, and then return substantive results accordingly, such as converted addresses, cleansed or enhanced data values, and so on. However, in some embodiments that substantive result is ignored or discarded, because it is the existence of the output which is utilized by the embodiment, rather than the content of the output data. Thus, some embodiments use data enhancement service(s) 204 for a different purpose than the purpose they were primarily meant to provide.

A “likelihood” 240 may be absolute, or it may be a probability 238. That is, some embodiments assign 314 a likelihood by assigning a semantic category 210 matching the data enhancement service's semantic criterion for submitted data, e.g., the data is semantically phone-data (or more generally, contact-data). Some embodiments assign 314 a likelihood by assigning a probability that the submitted data values 128 belong to a semantic category matching the data enhancement service's semantic criterion for submitted data, e.g., there is a 85% chance that the data is semantically street-address data.

As for responses 212, a data enhancement service 204 may return a success code or an error code to an embodiment, or the service 204 may indicate successful conversion merely by returning converted data and thus implicitly indicating that the semantic criteria 236 for input data were met. These embodiments assign a semantic categorization 210 (absolute or probability) to the submitted data values based on the response 212. For instance, if data is given to a service 204 that converts street addresses to latitude-longitude coordinates and the response 2121 from the service indicates that the conversion succeeded, then the input data may be assigned a “street-address” or an “address” semantic categorization 210. Likewise, if the phone number to city-and-state conversion service 204 succeeds, then the input data may be assigned a “phone-number” or a “contact-info” semantic categorization. More generally, these embodiments choose a semantic categorization 210 of the data values 128 sent to the service 204 based on the way the service responds to those data values and on what the service expects, semantically, from its input data.

In general, a variety of data enhancement services 204 can be used in this manner as part of semantic categorization. For example, the data enhancement service(s) used by a given embodiment may be configured to provide one or more of the following services: removal of duplicate records; suppression of do-not-contact records (e.g., for do-not-call list enrollees, deceased individuals, incarcerated persons, etc.); standardization of address data; addition of data values to facilitate completion of partial data records; spelling correction; address correction; correlation between electronic contact information and geographic location (e.g., phone number to city & state, IP address to city & state, etc.); correlation between different geographic location formats (e.g., street address to latitude & longitude coordinates, etc.); correlation of records with demographic information; correlation of records with financial information; correlation of records with purchasing information.

Other semantic categorization operations do not necessarily use a data enhancement service 204. For example, some embodiments obtain 302 data values from a set of data records and perform 304, 312 semantic categorization based, at least in part, on which device was used to collect the data values. Thus, some embodiments choose 312 a semantic categorization of location-data for data collected from a mobile device. Some embodiments choose 312 the semantic categorization of location-data when the device used is a global positioning system device, e.g., a GPS-equipped smartphone, PDA, or laptop. Some embodiments choose 312 a semantic categorization of location-data or a semantic categorization of identity-data when the device used is a web-browsing device (smartphone, laptop, workstation, etc.). Some embodiments choose 312 a semantic categorization of location-data or identity-data or financial-data, because the device used is a spreadsheet device (e.g., a laptop or workstation).

Some embodiments visualize 326 a semantic taxonomy 214 which shows a plurality of semantic categorizations 210 that include at least a semantic categorization of the obtained data values 128. For example, some display a graph which shows semantic categorizations for multiple datasets (represented by names and/or icons) and connections between datasets 122. Some show semantic categorizations for multiple datasets and then receive from a user at least one connection between displayed datasets. Some embodiments receive 328 a filtering request to filter datasets, and visualize 326 the taxonomy at least in part by displaying a result of the filtering request. In some, filtering requests 330 may be based partially or wholly on data content, dataset connection(s), and/or semantic categorization(s).

Although automatic semantic categorization is provided in many embodiments, and is the only kind of semantic categorization in some, manual edits may also be performed on semantic categorization in some embodiments. For example, some embodiments get 332 a request 230 for a manual change (i.e., a modification or deletion) in a semantic categorization 210 that was automatically chosen 312, selected 318, or assigned 310, and then computationally implement the requested manual change. Similarly, some get 332 a request 230 for a manual addition of a semantic categorization 210, and then computationally implement the requested manual addition. Manual change requests 230 may come from end users and/or from dataset publishers, for example.

Some embodiments store 334 (in non-volatile storage) different versions of the taxonomy 214. Some can retrieve specified taxonomy versions, and some can both store and retrieve multiple taxonomy versions in the context of multiple existing versions in a given usage environment 100. For example, some store different versions of the taxonomy for respective different users. Some embodiments use versioning code 232 to track how often a given user has picked a given version of the taxonomy, how often a given version of the taxonomy has been picked by any user, and/or how often a given version of the taxonomy has been picked by any user in a specified group of users. The group may be defined, e.g., by an entity organizational chart, a locale, a time frame, and/or other criteria. Some embodiments subject 336 a version of the taxonomy to crowdsourcing for feedback on semantic categorizations of the taxonomy.

In addition to, or in lieu of, the foregoing, some embodiments perform other actions. Some proactively map a 316 data record schema name (in a mapping 234) to a semantic category 210 in a hierarchy or mesh 218 of semantic categories. Some select 318 a semantic categorization 210 of data values based at least in part on a subject heading in which data was published, e.g., a subject heading applied by an educational institution or a governmental agency to a publication of the data values. Some assess 322 similarity between the data values obtained and other data values which have previously been semantically categorized, and categorize accordingly. Some embodiments identify 324 a semantic categorization of the data values based at least in part on a syntactic pattern 220 exhibited in at least some of the data values. Some embodiments display 326 a computed probability that a semantic categorization is accurate.

Some embodiments proactively cleanse 320 a data record schema name, e.g., by removing numeric digits, dashes, underscores, etc. Some suggest 338 a related dataset 122, based at least in part on the semantic categorizations of a given dataset. Some perform 304 a semantic categorization operation in a browser, and some use another application or service. Some operate as a pre-processor, back-end, or other operation that is not readily visible per se to users, although results and/or benefits of the semantic categorization are available to users.

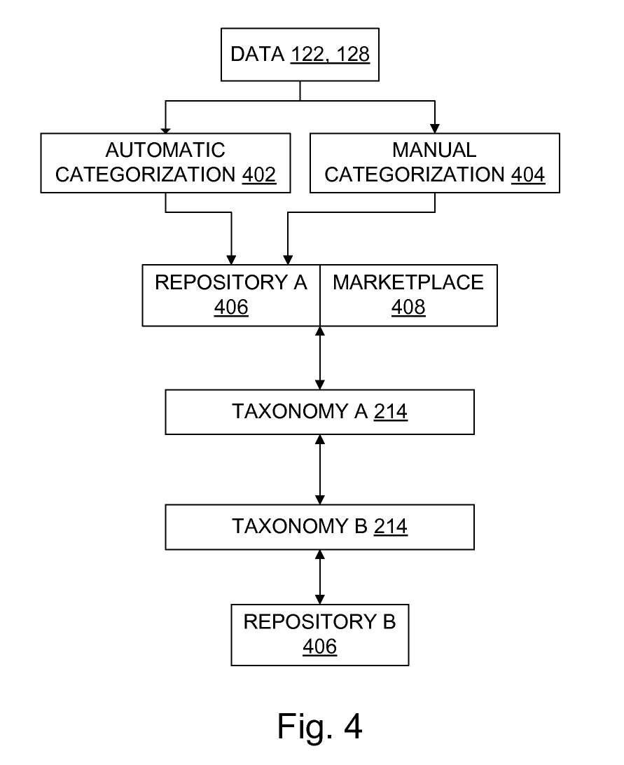

FIG. 4 illustrates some aspects of semantic categorization in a federated taxonomy environment. Data values 122/128 are submitted for automatic semantic categorization 402 by a module 206 which computationally and automatically (and in some cases proactively) performs 304 semantic categorization. The same and/or other data values 128 are also subject to manual semantic categorization 404, which although implemented by editing code 228 and change requests 230, is generated directly by users 104. The resulting categorizations 210 are maintained in a repository 406, which may be implemented as a database, a data store, and/or other structured data.

In the illustrated environment, the semantic categorizations 210 may be offered in a marketplace 408, such as a Microsoft® Windows Azure™ marketplace or other data/service marketplace (marks of Microsoft Corporation). Semantic categorizations 210 may be offered as integral parts of the associated dataset packages, or as optional add-on purchases, or independently of the underlying datasets 122 as products in their own right.

Taxonomies 214 generated at different sites, by different entities, using different implementations, and/or different datasets, for example, may be federated by providing a uniform access mechanism. For instance, users 104 may be given access to federated taxonomies through versioning code 232, visualization code 226, and/or similarity assessor 224 code, which reads/writes those several taxonomies 214.

Configured Media

Some embodiments include a configured computer-readable storage medium 112. Medium 112 may include disks (magnetic, optical, or otherwise), RAM, EEPROMS or other ROMs, and/or other configurable memory, including in particular non-transitory computer-readable media (as opposed to wires and other propagated signal media). The storage medium which is configured may be in particular a removable storage medium 114 such as a CD, DVD, or flash memory. A general-purpose memory, which may be removable or not, and may be volatile or not, can be configured into an embodiment using items such as semantic categorizations 210 and semantic categorization modules 206, in the form of data 118 and instructions 116, read from a removable medium 114 and/or another source such as a network connection, to form a configured medium. The configured medium 112 is capable of causing a computer system to perform process steps for transforming data through semantic categorization as disclosed herein. FIGS. 1 through 4 thus help illustrate configured storage media embodiments and process embodiments, as well as system and process embodiments. In particular, any of the process steps illustrated in FIG. 3 and/or FIG. 4, or otherwise taught herein, may be used to help configure a storage medium to form a configured medium embodiment.

### Additional Examples

Additional details and design considerations are provided below. As with the other examples herein, the features described may be used individually and/or in combination, or not at all, in a given embodiment.

Those of skill will understand that implementation details may pertain to specific code, such as specific APIs and specific sample programs, and thus need not appear in every embodiment. Those of skill will also understand that program identifiers and some other terminology used in discussing details are implementation-specific and thus need not pertain to every embodiment. Nonetheless, although they are not necessarily required to be present here, these details are provided because they may help some readers by providing context and/or may illustrate a few of the many possible implementations of the technology discussed herein.

The following discussion is derived from documentation for Microsoft® Windows Azure™ marketplace (marks of Microsoft Corporation). Aspects of this marketplace and/or documentation are consistent with or otherwise illustrate aspects of the embodiments described herein. However, it will be understood that the marketplace documentation and/or implementation choices do not necessarily constrain the scope of such embodiments, and likewise that the marketplace and/or its documentation may well contain features that lie outside the scope of such embodiments. It will also be understood that the discussion below is provided in part as an aid to readers who are not necessarily of ordinary skill in the art, and thus may contain and/or omit details whose recitation below is not strictly required to support the present disclosure.

Data that's published to be used by others or also stored for personal use sometimes doesn't come with an easily understood schema. Such data may have poor descriptions. Such deficiencies make it hard for machines or other people to understand the data, work with the data, enhance the data, connect the data with other data sources, and so on.

Some embodiments discussed herein include an encoding engine (e.g., module 206) that reads the data and processes it. The engine identifies patterns and matches the patterns against a repository 406 to categorize data. This engine returns a probability 238 that a certain set of data (column or vector) contains data of a certain kind (phone number, address, gender information, time, first name, city, etc.). In some cases, the engine bases its processing on the context of the data being used, e.g. has this data been collected by using certain devices, has the data been published in a certain category, and so on. Using the context helps the engine identify the data in more detail.

In some cases, the schema 124 names (column names, field names) are used to infer what kind of information data could contain. Synonyms are looked up to get a better understanding of the names. Name cleansing patterns (e.g. removing numbers, dashes, underscores, etc.) are used to get a better understanding what the creator of the data meant by a field/column name.

Some embodiments define conceptual mappings 234 (e.g., categorization mappings) for the schema names and perform the mapping based on the concepts and synonyms of the concepts instead of the names.

In some cases, other data in the repository/marketplace is used to assess 322 whether there are similarities between the data that is being published/stored and the data that's already available. Semantics defined for the already published datasets can help to determine the semantics for the new datasets.

In some embodiments, a set of pre-defined patterns 220 are taken to identify fields that contain addresses, phone numbers, etc.

In some embodiments, third party services 204 (available in the marketplace/repository and outside) are used to cleanse or enhance the fields before applying other steps described herein.

In some embodiments, semantic categorization is not limited to happen on one field/column or row at a time. Multiple columns or rows that seem to be related can be combined to reach better results. For instance, if one column contains the first name and the other one the last name they can be combined to determine whether the pair represents people's names, then the columns can be split up into first and last name. Consider “Kirkland” and “Smith”. Kirkland is a city but can also be a person's name. Both fields can be combined and look like a name. They then can be split into two, where Smith is very likely a last name and the other field probably contains a first name. The same approach applies to multiple rows, where combining two or more rows might yield better results then only identifying one row at a time.

Some embodiments use one or more of the foregoing techniques together to generate automatic annotations to describe the semantics of the data. Combining steps such as steps 310, 312, 318 may be done via voting, defaults, and/or or other mechanisms to determine the semantic categorizations 210. Weights, thresholds and confidence levels (probabilities 238) can be attached to any step to favor one mechanism over the other(s). For instance, one approach triggering one field/column to be in semantic category X counts more than two other approaches marking it as belonging to category Y. But if three others mark it as Y these three win.

In some embodiments, translation (a.k.a. cleansing) functions can be used to enhance the annotation results and resolve the variations in data. Translation functions may include, for example, translating from an abbreviation to a long form, synonyms, language translation, upper/lower case, numbers (3 vs three), etc.

In some embodiments, in additional to the automatic annotation there's also a manual component. In some, the data publishers are allowed to manually set the annotations (categorizations 210), to correct the automatic annotations that have been generated by the algorithm, or otherwise set. In some cases, users who use the data are also able to adjust the annotations, add their own, and edit existing ones. Users usually have a great understanding of the data—after having worked with it for a bit they can make reliable judgments on whether something is accurate or not. In some embodiments, separate versions of the annotations can be saved 334 per user, so that other users can pick whichever version they like more. How often certain users have picked a certain version may also be stored.

In some embodiments, a generated semantics (taxonomy) can then be displayed and visualized 326 to the user in a variety of forms. A graph containing all the semantics and annotations in the system (in a Taxonomy Browser, for instance) permits the end-user to see connections between datasets, connect the datasets, filter datasets that contain certain data or connections, etc. In some cases, the browser classified the data (from a user's perspective) and shows the user how likely an annotation applies to a field.

By using annotations 210 a recommendation engine can then, in combination with the user preferences, suggest 338 other related data, in some embodiments. For instance, if the user looks or uses data of shape X the recommendation engine knows which other data or datasets contain data similar to shape X and can recommend that to the user. The user can provide an example of data and then the system can suggest 338 what data in the taxonomy would work with the data example the user is providing.

In some embodiments, the system's taxonomy 214 can then also be federated with other taxonomies. That is, a taxonomy generated for repository A can also be federated with repository B so that datasets 122 in repository B can leverage the taxonomy(ies) of repository A. This permits a rich set of functionality for federation code 216, allowing that code, e.g., to increase the categorization 210 accuracy in repository B because it leverages two (or more) taxonomies during automatic annotation, to connect datasets from various repositories together, to permit users to explore more data by following connections, to search across multiple repositories, and to provide a shared understanding of how data relates even though schemas are different.

### CONCLUSION

Although particular embodiments are expressly illustrated and described herein as processes, as configured media, or as systems, it will be appreciated that discussion of one type of embodiment also generally extends to other embodiment types. For instance, the descriptions of processes in connection with FIG. 3 also help describe configured media, and help describe the operation of systems and manufactures like those discussed in connection with other Figures. It does not follow that limitations from one embodiment are necessarily read into another. In particular, processes are not necessarily limited to the data structures and arrangements presented while discussing systems or manufactures such as configured memories.

Not every item shown in the Figures need be present in every embodiment. Conversely, an embodiment may contain item(s) not shown expressly in the Figures. Although some possibilities are illustrated here in text and drawings by specific examples, embodiments may depart from these examples. For instance, specific features of an example may be omitted, renamed, grouped differently, repeated, instantiated in hardware and/or software differently, or be a mix of features appearing in two or more of the examples. Functionality shown at one location may also be provided at a different location in some embodiments.

Reference has been made to the figures throughout by reference numerals. Any apparent inconsistencies in the phrasing associated with a given reference numeral, in the figures or in the text, should be understood as simply broadening the scope of what is referenced by that numeral.

As used herein, terms such as “a” and “the” are inclusive of one or more of the indicated item or step. In particular, in the claims a reference to an item generally means at least one such item is present and a reference to a step means at least one instance of the step is performed.

Headings are for convenience only; information on a given topic may be found outside the section whose heading indicates that topic.

All claims and the abstract, as filed, are part of the specification.

While exemplary embodiments have been shown in the drawings and described above, it will be apparent to those of ordinary skill in the art that numerous modifications can be made without departing from the principles and concepts set forth in the claims, and that such modifications need not encompass an entire abstract concept. Although the subject matter is described in language specific to structural features and/or procedural acts, it is to be understood that the subject matter defined in the appended claims is not necessarily limited to the specific features or acts described above the claims. It is not necessary for every means or aspect identified in a given definition or example to be present or to be utilized in every embodiment. Rather, the specific features and acts described are disclosed as examples for consideration when implementing the claims.

All changes which fall short of enveloping an entire abstract idea but come within the meaning and range of equivalency of the claims are to be embraced within their scope to the full extent permitted by law.

What is claimed is:

1. A computer-readable storage medium configured with data and with instructions that when executed by at least one processor causes the processor(s) to perform a process for semantic categorization of data, the process comprising the computational steps of:
obtaining data values from a set of data records; and
performing at least one of the following semantic categorization operations with the data values:
submitting the data values to a data enhancement service which has at least one semantic criterion for incoming data, receiving a response from the data enhancement service that indicates whether the submitted data values meet the at least one semantic criterion, and then assigning a semantic categorization to the submitted data values based on the response, the data enhancement service providing one or more of the following services: removal of duplicate records, suppression of do-not-contact records, standardization of address data, addition of data values to facilitate completion of partial data records, spelling correction, address correction, correlation of records with demographic information, correlation of records with financial information, correlation of records with purchasing information; or
choosing a semantic categorization of the data values based expressly, at least in part, on which device was used to collect the data values.

2. The configured medium of claim 1, wherein the submitting step occurs, the response indicates that the submitted data values do meet at least one semantic criterion for data which is submitted to the data enhancement service, and the assigning step assigns an increased likelihood that the submitted data values belong to a semantic category matching the data enhancement service's semantic criterion for submitted data.

3. The configured medium of claim 1, wherein the submitting step occurs, the response indicates that the submitted data values do not meet at least one semantic criterion for data which is submitted to the data enhancement service, and the assigning step assigns a decreased likelihood that the submitted data values belong to a semantic category matching the data enhancement service's semantic criterion for submitted data.

4. The configured medium of claim 1, wherein the submitting step occurs, and the data enhancement service is configured to provide at least four of the following:
removal of duplicate records;
suppression of do-not-contact records;
standardization of address data;
addition of data values to facilitate completion of partial data records;
spelling correction;
address correction;
correlation between electronic contact information and geographic location;
correlation between different geographic location formats;
correlation of records with demographic information;
correlation of records with financial information;
correlation of records with purchasing information.

5. The configured medium of claim 1, wherein the choosing step occurs, and the semantic categorization and the device used conform to at least one of the following:
the semantic categorization is location-data and the device used is a mobile device;
the semantic categorization is location-data and the device used is a global positioning system device;
the semantic categorization is location-data or identity-data, and the device used is a web-browsing device;
the semantic categorization is location-data or identity-data or financial-data, and the device used is a spreadsheet device.

6. The configured medium of claim 1, wherein the process comprises at least one of the following:
assigning a likelihood by assigning a probability that the submitted data values belong to a semantic category matching the data enhancement service's semantic criterion for submitted data;
proactively mapping a data record schema name to a semantic category in a hierarchy of semantic categories;
selecting a semantic categorization of the data values based at least in part on a subject heading applied by an educational institution or a governmental agency to a publication of the data values.

7. The configured medium of claim 1, wherein the process comprises at least three of the following:
assigning a likelihood by assigning a semantic category matching the data enhancement service's semantic criterion for submitted data;
proactively cleansing a data record schema name;
assessing similarity between the data values and other data values which have previously been semantically categorized;
identifying a semantic categorization of the data values based at least in part on a syntactic pattern exhibited in at least some of the data values.

8. A computational process for semantic categorization of data, the process comprising the steps of:
obtaining a dataset which contains data values;
computationally performing at least one of the following semantic categorization operations with the data values:
automatically submitting the data values to a data enhancement service which has at least one semantic criterion for incoming data, receiving a response from the data enhancement service that indicates whether the submitted data values meet the at least one semantic criterion, and then assigning a semantic categorization to the submitted data values based on the response, the data enhancement service providing at least three of the following services: removal of duplicate records, suppression of do-not-contact records, standardization of address data, addition of data values to facilitate completion of partial data records, spelling correction, address correction, correlation of records with demographic information, correlation of records with financial information, correlation of records with purchasing information;
automatically choosing a semantic categorization of the data values based expressly, at least in part, on which device was used to collect the data values; or
automatically selecting a semantic categorization of the data values based at least in part on a subject heading applied in a publication of the data values; and
visualizing for a user a semantic taxonomy which shows a plurality of semantic categorizations that include at least a semantic categorization of the data values.

9. The computational process of claim 8, wherein the process comprises at least one of the following:
visualizing the taxonomy at least in part by displaying a graph which shows semantic categorizations for multiple datasets and connections between datasets;
visualizing the taxonomy at least in part by displaying a graph which shows semantic categorizations for multiple datasets, and then receiving from a user at least one connection between datasets;
receiving from the user a filtering request to filter datasets based at least in part on data content, and visualizing the taxonomy at least in part by displaying a result of the filtering request;
receiving from the user a filtering request to filter datasets based at least in part on dataset connection(s), and visualizing the taxonomy at least in part by displaying a result of the filtering request;
receiving from the user a filtering request to filter datasets based at least in part on semantic categorization(s), and visualizing the taxonomy at least in part by displaying a result of the filtering request.

10. The computational process of claim 8, wherein the process further comprises at least one of the following:
getting from the user a request for a manual change in a semantic categorization that was automatically chosen, selected, or assigned, and then computationally implementing the requested manual change;
getting from the user a request for a manual addition of a semantic categorization, and then computationally implementing the requested manual addition;
getting from a dataset publisher a request for a manual change in a semantic categorization that was automatically chosen, selected, or assigned, and then computationally implementing the requested manual change;
getting from a dataset publisher a request for a manual addition of a semantic categorization, and then computationally implementing the requested manual addition.

11. The computational process of claim 8, wherein the process further comprises at least one of the following:
storing different versions of the taxonomy;
storing different versions of the taxonomy for respective different users;
tracking how often a given user has picked a given version of the taxonomy;
tracking how often a given version of the taxonomy has been picked by any user;
tracking how often a given version of the taxonomy has been picked by any user in a specified group of users;
subjecting a version of the taxonomy to crowdsourcing for feedback on semantic categorizations of the taxonomy.

12. The computational process of claim 8, wherein the process further comprises at least one of the following:
suggesting to the user a related dataset, based at least in part on the semantic categorizations of the dataset;
performing the semantic categorization operation in a browser;
displaying a computed probability that a semantic categorization is accurate.

13. The computational process of claim 8, wherein the obtaining step electronically obtains at least a portion of the dataset from at least one of the following:
an application program;
an online marketplace;
a website;
a web service;
a database management system;
a data store;
an XML document.

14. A computer system comprising:
at least one logical processor;
a memory in operable communication with the logical processor; and
at least one data enhancement service interface residing in the memory, the interface including an interface to a data enhancement service which has at least one semantic criterion for incoming data, the data enhancement service providing at least two of the following services: removal of duplicate records, suppression of do-not-contact records, standardization of address data, addition of data values to facilitate completion of partial data records, spelling correction, correlation of records with demographic information, correlation of records with financial information, correlation of records with purchasing information;
a semantic categorization module residing in the memory in operable communication with the data enhancement service interface(s), the semantic categorization module containing code which upon execution by the logical processor(s) will proactively submit data values to the data enhancement service interface, receive a response from the data enhancement service interface that indicates whether the submitted data values meet the at least one semantic criterion, and then assign a semantic categorization to the submitted data values based on the response.

15. The system of claim 14, wherein the system further comprises:
a first semantic taxonomy which includes a first plurality of semantic categorizations of data values of a first dataset; and
taxonomy federation code which upon execution by the logical processor(s) will access a second semantic taxonomy which includes a second plurality of semantic categorizations of data values of a second dataset and then perform at least one of the following taxonomy federation operations:
report that a semantic categorization appears in both the first taxonomy and the second taxonomy;
report that multiple semantic categorizations appear in both the first taxonomy and the second taxonomy;
report that the second dataset has at least one semantic categorization in common with the first dataset;
report that the second dataset has multiple semantic categorizations in common with the first dataset.

16. The system of claim 14, wherein the semantic categorization module is owned by an entity, and the data enhancement service interface(s) connect the semantic categorization module with at least one third party data enhancement service which is owned by another entity.

17. The system of claim 14, wherein the system further comprises a dataset having a schema and having semantic categorizations which are a generalization of the schema, and wherein the semantic categorizations are connected within a mesh of semantic categorizations.

18. The system of claim 14, wherein the system further comprises at least four of the following:
a predefined syntactic pattern for identifying data values as street addresses;
a predefined syntactic pattern for identifying data values as postal addresses;
a predefined syntactic pattern for identifying data values as latitude-longitude coordinates;
a predefined syntactic pattern for identifying data values as email addresses;
a predefined syntactic pattern for identifying data values as website addresses;
a predefined syntactic pattern for identifying data values as telephone numbers;
a predefined syntactic pattern for identifying data values as calendar dates;
a predefined syntactic pattern for identifying data values as gender information;
a predefined syntactic pattern for identifying data values as city and state information;
a predefined syntactic pattern for identifying data values as postal codes.

19. The system of claim 14, wherein the system further comprises at least two of the following:
code which upon execution by the processor(s) will cleanse a dataset schema name;
code which upon execution by the processor(s) will assess similarity between a first dataset and a second dataset, at least one of the datasets having semantic categorizations;
code which upon execution by the processor(s) will choose a semantic categorization of a data value based at least in part on which device was used to collect the data value;
code which upon execution by the processor(s) will select a semantic categorization of a data value based at least in part on a subject heading applied in a publication of the data value; and
code which upon execution by the processor(s) will visualize for a user a taxonomy which shows a plurality of semantic categorizations.

20. The system of claim 14, wherein the system further comprises at least three of the following:
code which upon execution by the processor(s) will get a request for a manual change in a semantic categorization;
code which upon execution by the processor(s) will get a request for a manual addition of a semantic categorization;
code which upon execution by the processor(s) will store different versions of a semantic taxonomy in non-volatile storage;
code which upon execution by the processor(s) will track respective usage of different versions of a semantic taxonomy;
code which upon execution by the processor(s) will suggest a relationship between datasets, based at least in part on semantic categorizations of the datasets.
